(19) United States
(12) Patent Application Publication
(10) Pub. No.: US 2017/0350318 A1
(43) Pub. Date: Dec. 7, 2017

(54) HYBRID COMPRESSED AIR ENERGY STORAGE SYSTEM AND PROCESS

(71) Applicant: DRESSER-RAND COMPANY, Olean, NY (US)

(72) Inventors: Joseph T. Williams, Kirkland, WA (US); Jason M. Kerth, Houston, TX (US)

(21) Appl. No.: 15/602,179

(22) Filed: May 23, 2017

Related U.S. Application Data
(60) Provisional application No. 62/346,587, filed on Jun. 7, 2016.

(51) Int. Cl. F02C 6/16; F02C 3/14; F01D 15/10; F02C 7/14; F02C 3/04

(52) U.S. Cl. CPC F02C 6/16; F02C 7/14; F02C 3/04; F01D 15/10; F02C 3/14; F05D 2240/35; F05D 2260/42

(57) ABSTRACT

A hybrid compressed air energy storage system is provided. A method of operation thereof includes compressing air during a storage period, and extracting thermal energy therefrom to produce a cooled compressed air. The cooled compressed air may be stored in an air storage unit, the extracted thermal energy may be stored in a thermal storage device, and the stored cooled compressed air may be heated with the stored extracted thermal energy to produce a heated compressed air during a generation period. The heated compressed air may be expanded with an expander to generate power and discharge an expanded air, which may be heated with a recuperator to produce a heated expanded air. A fuel mixture including the heated expanded air may be combusted to produce an exhaust gas, which may be expanded with a second expander to generate power and discharge the expanded exhaust gas to the recuperator.

### CROSS-REFERENCE TO RELATED APPLICATIONS

This application claims the benefit of U.S. Provisional Patent Application having Ser. No. 62/346,587, which was filed Jun. 7, 2016. The aforementioned patent application is hereby incorporated by reference in its entirety into the present application to the extent consistent with the present application.

### BACKGROUND

Compressed air energy storage (CAES) systems store excess power from an electrical grid during periods of excess electricity and generate electricity to upload to the electrical grid during high demand periods. The CAES systems produce stored energy by compressing and storing a gas during the periods of excess electricity and generate electricity by expanding the stored compressed gas during the high demand periods.

An adiabatic CAES system and a diabatic CAES system are two types of CAES systems used to stored and regenerate energy. The adiabatic CAES system stores thermal energy produced as the heat of compression when compressing and storing the gas. Thereafter, the adiabatic CAES system heats the stored compressed gas with the stored thermal energy before expanding the stored compressed gas to generate electricity. Conversely, the diabatic CAES system rejects the heat of compression energy into the environment outside of the system, thus essentially wasting the energy used to perform the work of compression. Therefore, the diabatic CAES system typically heats the stored compressed gas by burning a fuel prior to expanding the stored compressed gas to generate electricity.

Both adiabatic and diabatic CAES systems may have shortcomings due to design and cost constraints. The adiabatic CAES system typically produces lower output power due to the reduced average temperature during the expansion/generation phase, resulting in a higher cost per kW produced. The adiabatic CAES system has added expenses when recovering electricity due to the loss of compression heat and subsequent cost of reheating the stored air. Both adiabatic and diabatic CAES systems typically discharge exhaust gas into the ambient atmosphere at above ambient temperatures (e.g., greater than 70° F.), resulting in the loss of thermal energy. Increases in such thermal energy losses correlate to greater system inefficiencies.

There is a need, therefore, for improved CAES systems and methods that provide greater efficiencies and reduced cost to store and recover energy.

### SUMMARY

Embodiments of the disclosure may provide a hybrid compressed air energy storage system. The hybrid compressed air energy storage system may include a compressor configured to receive and compress air and discharge a compressed air. The hybrid compressed air energy storage system may also include a first heat exchanger configured to receive the compressed air discharged by the compressor, extract thermal energy from the compressed air, and discharge a cooled compressed air. The hybrid compressed air energy storage system may further include an air storage unit configured to receive and store the cooled compressed air discharged by the first heat exchanger and discharge a stored compressed air. The hybrid compressed air energy storage system may also include a thermal storage device configured to receive and store the thermal energy extracted by the first heat exchanger. The hybrid compressed air energy storage system may further include a second heat exchanger configured to transfer thermal energy stored by the thermal storage device to the stored compressed air discharged by the air storage unit and discharge a heated compressed air. The hybrid compressed air energy storage system may also include a first expander configured to receive and expand the heated compressed air discharged by the second heat exchanger, produce power, and discharge an expanded air. The hybrid compressed air energy storage system may further include a recuperator configured to receive and heat the expanded air from the first expander and discharge a heated expanded air. The recuperator may also be configured to receive and cool an expanded exhaust gas and discharge a cooled exhaust gas. The hybrid compressed air energy storage system may also include a first combustor configured to receive the heated expanded air and discharge an exhaust gas. The hybrid compressed air energy storage system may further include a second expander configured to receive and expand the exhaust gas discharged by the first combustor, produce power, and discharge the expanded exhaust gas.

Embodiments of the disclosure may further provide a hybrid compressed air energy storage system. The hybrid compressed air energy storage system may include a compressor configured to receive and compress air and discharge a compressed air. The hybrid compressed air energy storage system may also include a first heat exchanger configured to receive the compressed air discharged by the compressor, extract thermal energy from the compressed air, and discharge a cooled compressed air. The hybrid compressed air energy storage system may further include an air storage unit configured to receive and store the cooled compressed air discharged by the first heat exchanger and discharge a stored compressed air. The hybrid compressed air energy storage system may also include a thermal storage device configured to receive and store the thermal energy extracted by the first heat exchanger. The hybrid compressed air energy storage system may further include a second heat exchanger configured to transfer thermal energy stored by the thermal storage device to the stored compressed air discharged by the air storage unit and discharge a heated compressed air. The hybrid compressed air energy storage system may also include a very high pressure expander configured to receive and expand the heated compressed air discharged by the second heat exchanger, produce power, and discharge an expanded air. The hybrid compressed air energy storage system may further include a recuperator configured to receive and heat the expanded air from the very high pressure expander and discharge a heated expanded air. The hybrid compressed air energy storage system may also include a high pressure combustor configured to receive the heated expanded air, combust a first fuel mixture including the heated expanded air, and discharge a first exhaust gas. The hybrid compressed air energy storage system may further include a high pressure expander configured to receive and expand the first exhaust gas discharged by the high pressure combustor, produce power, and discharge a first expanded exhaust gas. The hybrid compressed air energy storage system may also include a low pressure combustor configured to receive the first expanded exhaust gas, combust a second fuel mixture including the first expanded exhaust gas, and discharge a second exhaust gas. The hybrid compressed air energy storage system may further include a low pressure expander configured to receive and expand the second exhaust gas discharged by the low pressure combustor, produce power, and discharge a second expanded exhaust gas, The recuperator may be further configured to receive and cool the second expanded exhaust gas and discharge a cooled exhaust gas.

Embodiments of the disclosure may further provide a method for storing and recovering energy by a hybrid compressed air energy storage system. The method may include compressing air with a compressor to produce a compressed air during a storage period, and extracting thermal energy from the compressed air to produce a cooled compressed air. The method may also include storing the cooled compressed air in an air storage unit, storing the extracted thermal energy in a thermal storage device, and heating the stored cooled compressed air with the stored extracted thermal energy to produce a heated compressed air during a generation period. The method may further include expanding the heated compressed air with a first expander to generate power and discharge an expanded air, and heating the expanded air with a recuperator to produce a heated expanded air, wherein the expanded air is heated by thermal energy extracted from an expanded exhaust gas. The method may also include combusting a fuel mixture including the heated expanded air to produce an exhaust gas, and expanding the exhaust gas with a second expander to generate power and discharge the expanded exhaust gas. The method may further include transferring the expanded exhaust gas to the recuperator.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 depicts a schematic diagram of an illustrative hybrid CAES system, according to one or more embodiments.

FIG. 2 depicts a schematic diagram of another illustrative hybrid CAES system, according to one or more embodiments.

FIG. 3 depicts a schematic diagram of another illustrative hybrid CAES system, according to one or more embodiments.

FIG. 4 depicts a flow chart of an illustrative method for storing and recovering energy with a hybrid CAES system, according to one or more embodiments.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

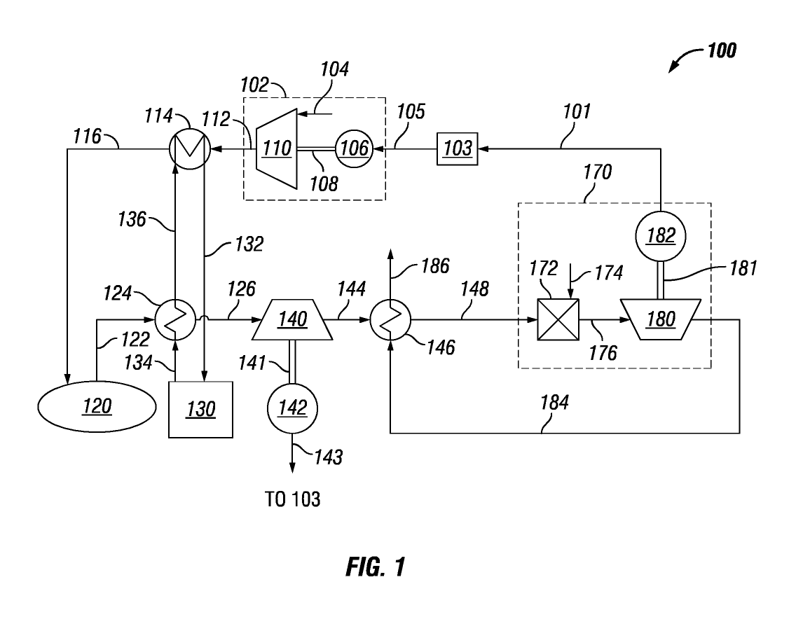

FIG. 1 depicts a schematic diagram of a hybrid compressed air energy storage (CAES) system 100, according to one or more embodiments. The hybrid CAES system 100 may be a hybrid adiabatic-diabatic CAES system that may have aspects of an adiabatic CAES system and a diabatic CAES system. The hybrid CAES system 100 may include one or more compressor units 102. Each compressor unit 102 may include one or more drivers 106 and one or more compressors 110. The driver 106 may power or drive the compressor 110 and may be coupled to the compressor 110 by one or more driveshafts 108. The compressor unit 102 may receive and compress a process gas, such as air, via line 104 and may discharge a compressed process gas, such as compressed air, via line 112 during generation periods. The process gas may be or include one or more working fluids or refrigerants. For example, an illustrative process gas may be or include, but is not limited to, air, nitrogen, oxygen, argon, carbon dioxide, methane, ethane, propane, or any mixture thereof. In one or more examples, the compressor 110 may receive and compress ambient air via line 104 and may discharge compressed air via line 112. The driver 106 may be or include, but is not limited to, one or more electric motors, one or more turbines or expanders, or a combination thereof. The compressor 110 may be or include, but is not limited to, one or more of a supersonic compressor, a centrifugal compressor, an axial flow compressor, a reciprocating compressor, a rotary screw compressor, a rotary vane compressor, a scroll compressor, or a diaphragm compressor. Additionally, the compressor 110 may include a single compressor stage or multiple compressor stages. Embodiments of the compressor 110 that include multiple compressor stages may include one or more heat exchangers (not shown) that extract thermal energy (e.g., heat of compression) from the compressed air between the compressor stages.

Although one compressor unit 102 containing one driver 106 and one compressor 110 are depicted in FIG. 1, any number of the compressor units 102 containing one or more drivers 106 and one or more compressors 110 may be used in a compressor train, not shown, in the hybrid CAES system 100. For example, the hybrid CAES system 100 may include, but is not limited to, 2, 3, 4, 5, 6, 7, 8, or more compressor units 102 containing one or more drivers 106 and one or more compressors 110.

In one or more embodiments, not shown, the hybrid CAES system 100 may include a first driver that may drive a first compressor, a second driver that may drive a second compressor, a third driver that may drive a third compressor, and a fourth driver that may drive a fourth compressor. In some examples, each pair of the driver 106 and the compressor 110 may be disposed together in a hermetically sealed casing (not shown). For example, the compressor units 102 containing one or more drivers 106 and one or more compressors 110 may be a DATUM® centrifugal compressor unit, commercially available from Dresser-Rand of Houston, Texas. In another example, one or more compressors 110 may be or include a DATUMS® supersonic compressor manufactured by Dresser-Rand of Houston, Tex.

One or more heat exchangers 114 may receive the compressed air via line 112 discharged by the compressor 110. The heat exchanger 114 may extract thermal energy (e.g., heat of compression) from the compressed air and may discharge a cooled compressed air via line 116. One or more air storage units 120 may receive the cooled compressed air via line 116 from the heat exchanger 114. The cooled compressed air may be stored or otherwise maintained with the air storage unit 120 as a stored compressed air. In some examples, the cooled compressed air via line 116 may be continuously flowed or otherwise transferred into the air storage unit 120 and maintained as the stored compressed air. In other examples, the cooled compressed air via line 116 may be intermittently flowed or otherwise transferred at different times into the air storage unit 120. Therefore, the stored compressed air maintained within the air storage unit 120 may be or include air from one batch or multiple batches.

During storage periods, one or more compressor units 102 (e.g., the compressor train) may compress air and/or one or more other process gases, and the compressed air or process gas may be introduced to and stored in the air storage unit 120. In some examples, the air storage unit 120 may be one or more caverns or one or more vessels. The air storage unit 120 may be or include, but is not limited to, one or more of: a rock cavern, a salt cavern, an aquifer, an abandoned mine, a depleted gas or oil field, a well, a container, tank, or vessel stored under water or the ground, a container, tank, or vessel stored on or above the ground.

One or more thermal storage devices 130 may receive and store the thermal energy via line 132 extracted by the heat exchanger 114 during storage periods. A heat transfer medium containing the thermal energy may be flowed or otherwise transferred from the heat exchanger 114 to the thermal storage device 130. The heat transfer medium containing the thermal energy may be maintained in the thermal storage device 130 until used during generation periods. Alternatively, the thermal energy may be transferred from the heat transfer medium to a thermal mass contained within the thermal storage device 130.

In some examples, not shown, if the hybrid CAES system 100 includes a compressor train, one or more additional heat exchangers 114 may be disposed between each stage or compressor unit 102 containing one or more drivers 106 and one or more compressors 110. Each additional heat exchanger 114 may be disposed downstream of each compressor 110 and may the cooled compressed air or other process gas to the air storage unit 120 and may transfer extracted thermal energy to the thermal storage device 130. For example, the hybrid CAES system 100 may include (not shown) a first heat exchanger downstream of a first compressor driven by a first driver, a second heat exchanger downstream of a second compressor driven by a second driver, a third heat exchanger downstream of a third compressor driven by a third driver, and a fourth heat exchanger downstream of a fourth compressor driven by a fourth driver.

In one or more embodiments, during generation periods, one or more heat exchangers 124 may receive the stored thermal energy via line 134 from the thermal storage device 130 and may also receive the stored compressed air from the air storage unit 120 via line 122. The heat exchanger 124 may transfer the stored thermal energy from the heat transfer medium via line 134 to the stored compressed air via line 122 to produce and may discharge a heated compressed air via line 126 and a cooled heat transfer medium via line 136. The heat exchanger 124 may discharge the heated compressed air at a temperature of about 350° F. (177° C.), about 400° F. (204° C.), or about 500° F. (260° C.) to about 600° F. (316° C.), about 800° F. (427° C.), or about 1,000° F. (534° C.). In another embodiment, heat exchangers 114 and 124 may be replaced by a single heat exchanger (not shown). A plurality of flow control valves (not shown) may be configured to direct the flow of the compressed air discharged by the compressor 110, the heat transfer medium, and the stored compressed air through the single heat exchanger.

The cooled heat transfer medium may be stored in a storage vessel (not shown) and/or may be transferred to the heat exchanger 114 via line 136. The heat transfer medium may be circulated in a thermal cycle between the heat exchanger 114, the thermal storage device 130, and the heat exchanger 124. Each of the heat exchangers 114, 124, as well as any other heat exchanger described and discussed herein, may be or include, but is not limited to, one or more of: a coil system, a shell-and-tube system, a direct contact system, or another type of heat transfer system.

The heat transfer medium may flow through the heat exchanger 114 and absorb thermal energy from the air or other process gas. Thus, the heat transfer medium has a greater temperature when exiting the heat exchanger 114 than when entering the heat exchanger 114; therefore, the heat transfer medium is heated within the heat exchanger 114 by the compressed air or other process gas via line 112. Also, the cooled compressed air or process gas via line 116 has a lower temperature when exiting the heat exchanger 114 than the compressed air via line 112 entering the heat exchanger 114; therefore, the compressed air is cooled within the heat exchanger 114 by the heat transfer medium via line 136.

Heat transfer mediums may be or include one or more working fluids or refrigerants and/or one or more liquid coolants. Illustrative heat transfer mediums may be or include, but are not limited to, thermal oil, water, steam, carbon dioxide, methane, ethane, propane, butane, other alkanes, ethylene glycol, propylene glycol, other glycol ethers, other organic solvents or fluids, one or more hydrofluorocarbons, one or more chlorofluorocarbons, or any combination thereof. One or more thermal masses contained within the thermal storage device 130 may store the extracted thermal energy and may release the stored thermal energy. The thermal mass may be in a solid state, a molten state, a liquid state, a fluid state, a superfluid state, a gaseous state, or any combination thereof. Illustrative thermal masses may be or include, but are not limited to, water, earth, mud, rocks, stones, concrete, metals, salts, or any combination thereof. In some examples, the thermal storage device 130 may be or include the thermal mass disposed within an insulated vessel or other container.

In other embodiments, not shown, during generation periods, the stored compressed air from the air storage unit 120 may be transferred to the thermal storage device 130. The stored compressed air may be heated by the thermal mass contained within the thermal storage device 130. The stored thermal energy in the thermal mass may be transferred to the stored compressed air to produce the heated compressed air. The stored thermal energy may be transferred to the stored compressed air by direct contact, or indirect contact (e.g., a heat exchanger), with the thermal mass.

During generation periods, the stored compressed air from the air storage unit 120 via line 122 may be drawn from the air storage unit 120, heated by the heat exchanger 124 to produce the heated compressed air via line 126, and used to power one or more expanders 140. The expander 140 may receive the heated compressed air discharged from the heat exchanger 124. In one or more examples, the expander 140 may be or include a very high pressure (VHP) expander. The expander 140 may expand the heated compressed air and may discharge an expanded air via line 144. The expanded air may have a temperature of about 70° F. (21° C.), about 100° F. (38° C.), about 150° F. (66° C.), or about 200° F. (93° C.) to about 250° F. (121° C.), about 300° F. (149° C.), or about 350° F. (177° C.) and may be at a pressure of about 400 psia (2.76 MPa), about 450 psia (3.10 MPa), about 500 psia (3.45 MPa), or about 550 psia (3.79 MPa) to about 600 psia (4.14 MPa), about 650 psia (4.48 MPa), about 700 psia (4.83 MPa), about 750 psia (5.17 MPa), or about 800 psia (5.52 MPa). In some examples, the thermal energy transferred from the thermal storage device 130 may be the only thermal energy used to heat or otherwise increase the temperature of the heated compressed air expanded by the expander 140.

The expander 140 may generate or otherwise produce power due to the expansion of the heated compressed air. In one or more examples, the expander 140 may produce electricity by powering one or more electrical generators 142 coupled thereto by one or more driveshafts 141. The electrical generator 142 may generate electricity and upload or otherwise transfer the generated electricity to an electrical grid 103 via line 143 during generation periods. The electrical generator 142 may generate a power of about 1 MW, about 4 MW, or about 7 MW to about 15 MW, about 18 MW, about 20 MW, about 23 MW, about 25 MW, about 27 MW, about 30 MW, or greater. In one or more examples, at least a portion of the generated electricity may be transferred from the electrical grid 103 via line 105 to one or more drivers 106, as shown, or may be transferred directly from the electrical generator 142 to one or more drivers 106 or other electrical devices, not shown. In other examples, not shown, the expander 140 may be coupled to and power or otherwise drive one or more pumps, one or more compressors, and/or pieces of other process equipment.

One or more recuperators 146 may receive the expander air via line 144, heat the expanded air, and discharge a heated expanded air via line 148. The recuperator 146 may also receive an expanded exhaust gas via line 184, cool the expanded exhaust gas, and discharge a cooled exhaust gas via line 186. For example, the cooled exhaust gas may be vented or otherwise released into the ambient atmosphere. The thermal energy in the expanded exhaust gas via line 184 may be transferred by the recuperator 146 to the expanded air via line 144 to produce the heated expanded air via line 148. The recuperator 146 may discharge the heated expanded air via line 148 at a temperature of about 350° F. (177° C.) to about 500° F. (260° C.), about 600° F. (316° C.), about 650° F. (343° C.), about 700° F. (371° C.), about 800° F. (427° C.), about 900° F. (482° C.), about 1,000° F. (534° C.), or greater.

Although not shown, the recuperator 146 may include a cooling portion and a heating portion. The recuperator 146 may transfer thermal energy from the cooling portion to the heating portion. More specifically, the recuperator 146 may transfer thermal energy from heated fluids or gases contained in the cooling portion to other fluids or gases contained in the heating portion. The recuperator 146 may be configured to transfer thermal energy from the expanded exhaust gas to the heated expanded air. For example, the cooling portion of the recuperator 146 may receive the expanded exhaust gas via line 184 and discharge the cooled exhaust gas via line 186, and the heating portion of the recuperator 146 may receive the first expanded air via line 144 and may discharge the heated expanded air via line 148.

In one or more embodiments, the expander 140 may be or include a VHP expander fluidly coupled to and disposed between the heat exchanger 124 and the recuperator 146, such as, for example, downstream of the heat exchanger 124 and upstream of the recuperator 146. The VHP expander 140 may be used to maximize the amount of thermal energy (heat of compression) that is recovered as electricity by the electrical generator 142 and may be used to minimize the temperature of the expanded air discharged from the expander 140. The less thermal energy contained in the expanded air introduced into the recuperator 146 via line 144, the more thermal energy may be transferred from the expanded exhaust gas in line 184 to the heated expanded air in line 148 by the recuperator 146. By maximizing the thermal energy transfer from the expanded exhaust gas via line 144 by the recuperator 146, less thermal energy may be lost or otherwise discharged with the cooled exhaust gas via line 186 outside of the hybrid CAES system 100. In some examples, the temperature of the expanded air via line 144 may be increased by greater than 100° F. (38° C.), greater than 150° F. (66° C.), greater than 200° F. (93° C.), greater than 250° F. (121° C.), greater than 300° F. (149° C.), greater than 350° F. (177° C.), greater than 400° F. (204° C.), greater than 450° F. (232° C.), or greater than 500° F. (260° C.) to produce the heated expanded air via line 148 by transferring thermal energy from the expanded exhaust gas via line 184 by the recuperator 146 to the expanded air via line 144.

The hybrid CAES system 100 may include one or more power generation units 170. Each of the power generation units 170 may include one or more combustors 172, one or more expanders 180, and one or more electrical generators 182. In one or more examples, the combustor 172 may be or include one or more low pressure (LP) combustors and the expander 180 may be or include one or more low pressure (LP) expanders. The heated expanded air via line 148 may be transferred to the combustor 172. One or more fuels, water, steam, one or more oxygen sources, additives, or any mixture thereof may be added or otherwise transferred to the combustor 172 via line 174 and combined with the heated expanded air in the combustor 172 to produce the fuel mixture. Alternatively, in another embodiment, the one or more fuels, water, steam, oxygen sources (e.g., O₂), and/or additives may be combined and mixed with the heated expanded air within the line 148 to produce the fuel mixture upstream of the combustor 172 (not shown). The fuel mixture containing the heated expanded air may be combusted within the combustor 172 to produce an exhaust gas. Illustrative fuels may be or include, but are not limited to, one or more hydrocarbon fuels (e.g., alkanes, alkenes, alkynes, or alcohols), hydrogen gas, syngas, or any combination thereof. Illustrative hydrocarbon fuels may be or include, but are not limited to, methane, ethane, acetylene, propane, butane, gasoline, kerosene, diesel, fuel oil, biodiesel, methanol, ethanol, or any mixture thereof.

Once the fuel mixture is combusted, the combustor 172 may discharge the exhaust gas via line 176 that is transferred to the expander 180. The expander 180 may receive and expand the exhaust gas via line 176 discharged by the combustor 172. The expander 180 may expand the exhaust gas to generate or otherwise produce power. In one or more examples, the expander 180 may produce electricity by powering or driving one or more electrical generators 182 coupled thereto by one or more driveshafts 181. The electrical generator 182 may generate electricity and upload or otherwise transfer the generated electricity to the electrical grid 103 via line 101 during generation periods. The electrical generator 182 may generate a power of less than about 10 MW, about 10 MW to about 50 MW, about 50 MW to about 150 MW, about 160 MW, about 165 MW, or about 168 MW to about 170 MW, about 175 MW, about 180 MW, or greater. In other examples, the expander 180 may be coupled to and power one or more pumps, one or more compressors, other rotary equipment, and/or other components that may be contained within the hybrid CAES system 100 or other systems (not shown).

The expander 180 may discharge an expanded exhaust gas via line 184. The expanded exhaust gas may have at a temperature of about 600° F. (316° C.), about 700° F. (371° C.), or about 750° F. (399° C.) to about 800° F. (427° C.), about 900° F. (482° C.), about 1,000° F. (534° C.), or about 1,200° F. (649° C.). The recuperator 146 may receive and cool the expanded exhaust gas via line 184 and may discharge the cooled exhaust gas via line 186. For example, the cooled exhaust gas may be discharged into the ambient atmosphere or transferred to other components contained within the hybrid CAES system 100 or other systems (not shown). The cooled exhaust gas may have a temperature of about 80° F. (27° C.), about 100° F. (38° C.) to about 200° F. (93° C.), about 212° F. (100° C.), about 250° F. (121° C.), about 300° F. (149° C.), or about 350° F. (177° C.) to less than 400° F. (204° C.), less than 500° F. (260° C.), or less than 550° F. (288° C.).

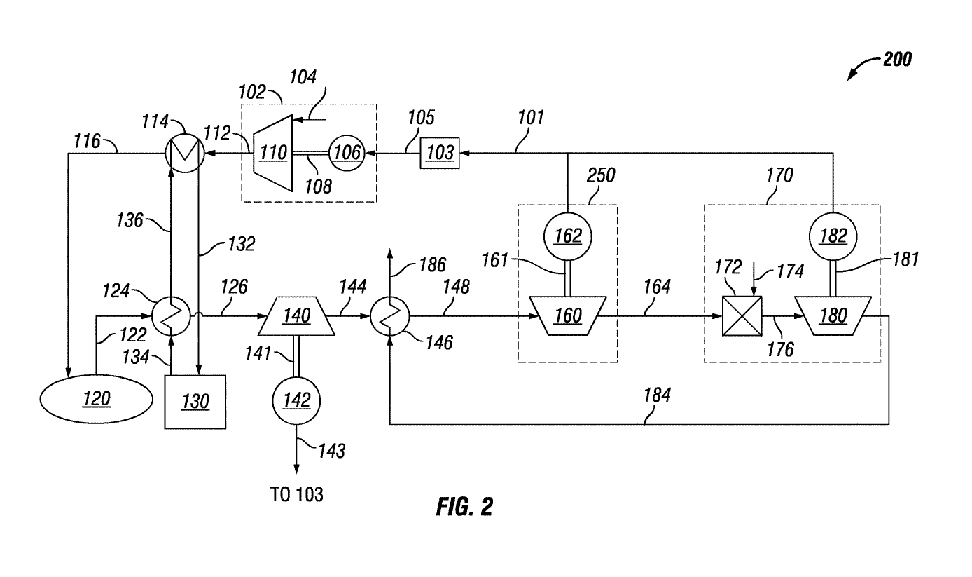

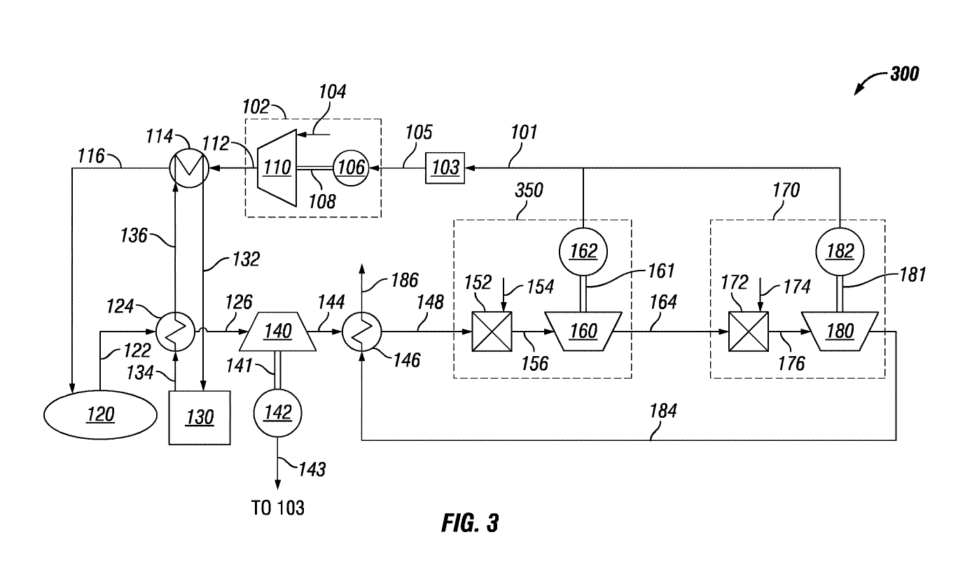

FIG. 2 depicts a schematic diagram of an illustrative hybrid CAES system 200 that may include one or more power generation units 250 fluidly coupled to and disposed between the recuperator 146 and the power generation unit 170, such as, for example, downstream of the recuperator 146 and upstream of the power generation unit 170. FIG. 3 depicts a schematic diagram of an illustrative hybrid CAES system 300 that may include one or more power generation units 350 disposed downstream of the recuperator 146 and upstream of the power generation unit 170. Each hybrid CAES system 200, 300 may be a hybrid adiabatic-diabatic CAES system that may have aspects of an adiabatic CAES system and a diabatic CAES system. The hybrid CAES systems 200, 300 or portions thereof depicted in FIGS. 2 and 3, respectively, and the hybrid CAES system 100 or portions thereof depicted FIG. 1 share many common components. It should be noted that like numerals shown in the Figures and discussed herein represent like components throughout the multiple embodiments disclosed herein.

Each of the power generation units 250, 350 may include one or more expanders 160 and one or more electrical generators 162, as depicted in FIGS. 2 and 3. The expander 160 may be or include one or more high pressure (HP) expanders. The power generation unit 350, depicted in FIG. 3, may also include one or more combustors 152 fluidly coupled to and disposed between the recuperator 146 and the expander 160, such as, for example, downstream of the recuperator 146 and upstream of the expander 160. The combustor 152 may be or include, but is not limited to, an external duct burner or a direct fired burner. In one or more embodiments, as depicted in FIG. 2, the expander 160 may receive via line 148 one or more heated expanded process gases, such as heated expanded air, discharged by the recuperator 146. The expander 160 may expand the heated expanded process gas or air to generate or otherwise produce power and may discharge one or more expanded process gases, such as expanded air, via line 164.

In one or more examples, the expander 160 may produce electricity by powering or driving one or more electrical generators 162 coupled thereto by one or more driveshafts 161. The electrical generator 162 may generate electricity and upload or otherwise transfer the generated electricity to the electrical grid 103 via line 101 during generation periods. The electrical generator 162 may generate a power of less than about 8 MW, about 8 MW, about 10 MW, about 14 MW, or about 18 MW to about 20 MW, about 25 MW, about 30 MW, about 32 MW, about 35 MW, or greater. In other examples, the expander 160 may be coupled to and power one or more pumps, one or more compressors, other rotary equipment, and/or other components that may be contained within the hybrid CAES systems 200, 300 or other systems (not shown).

In other embodiments, as depicted in FIG. 3, the combustor 152 may receive one or more heated expanded process gases, such as heated expanded air, via line 148 discharged by the recuperator 146. The combustor 152 may discharge an exhaust gas that may be received by the expander 160 via line 156. The expander 160 may expand the exhaust gas or other expanded process gas to generate or otherwise produce power and may discharge one or more expanded exhaust gases via line 164.

In one or more examples, the combustor 152 may be or include one or more high pressure (HP) combustors and the expander 160 may be or include one or more HP expanders. The heated expanded air may be transferred to the combustor 152 via line 148. One or more fuels, water, steam, one or more oxygen sources, additives, or any mixture thereof may be added or otherwise transferred to the combustor 152 via line 154 and combined with the heated expanded air in the combustor 152 to produce the fuel mixture. Alternatively, in another embodiment, the one or more fuels, water, steam, oxygen sources (e.g., O₂), and/or additives may be combined and mixed with the heated expanded air within the line 148 to produce the fuel mixture upstream of the combustor 152 (not shown). The fuel mixture containing the heated expanded air may be combusted within the combustor 152 to produce an exhaust gas. Illustrative fuels may be or include, but are not limited to, one or more hydrocarbon fuels (e.g., alkanes, alkenes, alkynes, or alcohols), hydrogen gas, syngas, or any combination thereof. Illustrative hydrocarbon fuels may be or include, but are not limited to, methane, ethane, acetylene, propane, butane, gasoline, kerosene, diesel, fuel oil, biodiesel, methanol, ethanol, or any mixture thereof.

Once the fuel mixture is combusted, the combustor 152 may discharge the exhaust gas that is transferred to the expander 160 via line 156. The expanded process gas may be transferred to the one or more combustors 172 via line 164 and combusted as discussed and described above. The expanded process gas may be or include, but is not limited to, air, exhaust gas, working fluid, or any mixture thereof. In one or more examples, the expanded process gas may be or include expanded air and may be discharged from the power generation unit 250 via line 164. In other examples, the expanded process gas may be or include expanded exhaust gas and may be discharged from the power generation unit 350 via line 164.

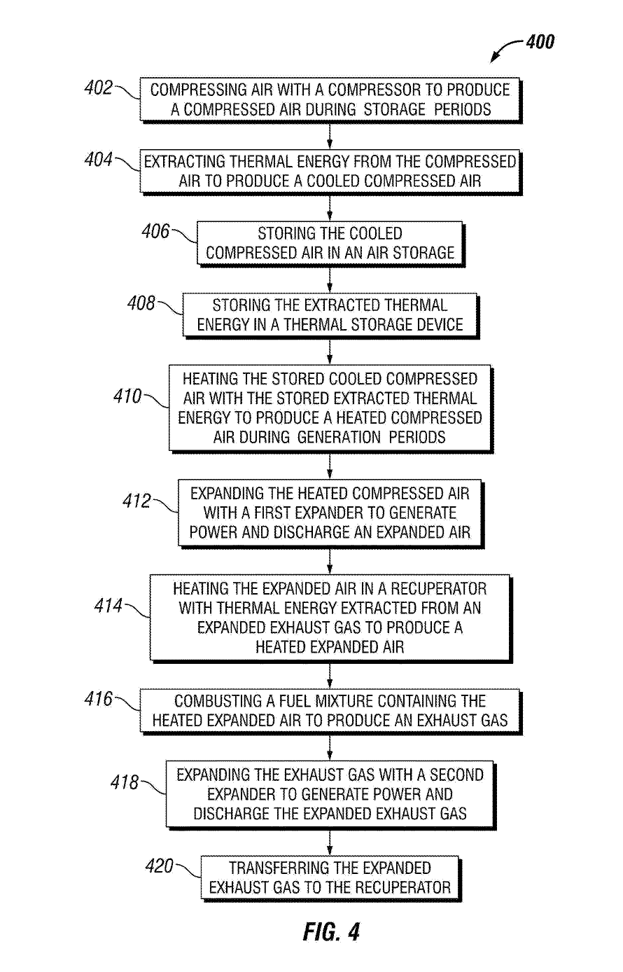

FIG. 4 depicts a flow chart of illustrative method 400 for storing and recovering energy with a hybrid CAES system, according to one or more embodiments. In some embodiments, the method 400 may be conducted on the hybrid CAES system 100, 200, and 300. The method 400 may include compressing air or process gas with one or more compressors to produce a compressed air or process gas during one or more storage periods, as shown at 402, and extracting thermal energy from the compressed air or process gas to produce a cooled compressed air or process gas, as shown at 404. The one or more compressors producing the compressed air or process gas may be powered by electricity transferred from an electrical grid during the one or more storage periods.

The method 400 may also include storing the cooled compressed air or process gas in one or more air storages, as shown at 406, and storing the extracted thermal energy in one or more thermal storage devices, as shown at 408. The method 400 may further include heating the stored cooled compressed air or process gas with the stored extracted thermal energy to produce a heated compressed air or process gas during one or more generation periods, as shown at 410. The method 400 may also include expanding the heated compressed air or process gas with one or more first expanders to generate power and discharge an expanded air or process gas, as shown at 412. The method 400 may further include heating the expanded air or process gas with one or more recuperators to produce a heated expanded air or process gas, as shown at 414. The expanded air or process gas may be heated by thermal energy extracted from one or more expanded exhaust gases that may be passing through the one or more recuperators. The method 400 may include combusting a fuel mixture containing the heated expanded air or process gas to produce an exhaust gas, as shown at 416.

The method 400 may also include expanding the exhaust gas with one or more second expanders to generate power and discharge the expanded exhaust gas, as shown at 418, and transferring the expanded exhaust gas to the one or more recuperators, as shown at 420. The expanded exhaust gases may be cooled in the recuperator to produce a cooled exhaust gas that may be vented into the ambient environment. The first expander may be coupled to one or more first electrical generators and the second expander may be coupled to one or more second electrical generators. The power generated by each of the first and second expanders may be used to produce electricity with the first and second electrical generators, respectively. Each of the first electrical generator, the second electrical generator, and one or more additional electrical generators may independently be coupled to the electrical grid and may upload or otherwise transfer the produced electricity to the electrical grid during the one or more generation periods.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We claim:

1. A hybrid compressed air energy storage system, comprising:
a compressor configured to receive and compress air and discharge a compressed air;
a first heat exchanger configured to receive the compressed air discharged by the compressor, extract thermal energy from the compressed air, and discharge a cooled compressed air;
an air storage unit configured to receive and store the cooled compressed air discharged by the first heat exchanger and discharge a stored compressed air;
a thermal storage device configured to receive and store the thermal energy extracted by the first heat exchanger;
a second heat exchanger configured to transfer thermal energy stored by the thermal storage device to the stored compressed air discharged by the air storage unit and discharge a heated compressed air;
a first expander configured to receive and expand the heated compressed air discharged by the second heat exchanger, produce power, and discharge an expanded air;
a recuperator configured to receive and heat the expanded air from the first expander and discharge a heated expanded air, and wherein the recuperator is configured to receive and cool an expanded exhaust gas and discharge a cooled exhaust gas;
a first combustor configured to receive the heated expanded air and discharge an exhaust gas; and
a second expander configured to receive and expand the exhaust gas discharged by the first combustor, produce power, and discharge the expanded exhaust gas.

2. The system of claim 1, wherein the first expander comprises a very high pressure expander coupled to a first electrical generator.

3. The system of claim 1, wherein the second expander comprises a low pressure expander coupled to a second electrical generator.

4. The system of claim 3, wherein the first combustor comprises a low pressure combustor.

5. The system of claim 1, wherein the recuperator is configured to remove thermal energy from the expanded exhaust gas to produce the cooled exhaust gas having a temperature of about 100° F. (38° C.) to less than 300° F. (149° C.).

6. The system of claim 1, wherein the first combustor is configured to combust a fuel mixture comprising the heated expanded air and a hydrocarbon fuel.

7. The system of claim 1, wherein the first combustor comprises a duct burner.

8. The system of claim 1, further comprising a third expander fluidly coupled between the recuperator and the first combustor, wherein the third expander is configured to receive and expand the heated expanded air from the recuperator.

9. The system of claim 8, wherein the third expander comprises a high pressure expander coupled to a third electrical generator.

10. The system of claim 8, further comprising a second combustor fluidly coupled between the recuperator and the third expander.

11. The system of claim 1, wherein the compressor is coupled to a driver, the driver comprising an electric motor or a turbine.

12. The system of claim 1, wherein the second heat exchanger is configured to receive and heat the stored compressed air discharged by the air storage unit and discharge the heated compressed air, and wherein the second heat exchanger is configured to receive and cool a heated thermal transfer medium from the thermal storage device and discharge a cooled thermal transfer medium.

13. The system of claim 1, wherein the heated compressed air expanded by the first expander is heated solely by the thermal energy transferred from the thermal storage device.

14. The system of claim 1, wherein the recuperator comprises a cooling portion and a heating portion and is configured to transfer thermal energy from the cooling portion to the heating portion, wherein the cooling portion is configured to receive the expanded exhaust gas and discharge the cooled exhaust gas, and wherein the heating portion is configured to receive the first expanded air and discharge the heated expanded air.

15. A hybrid compressed air energy storage system, comprising:
a compressor configured to receive and compress air and discharge a compressed air;
a first heat exchanger configured to receive the compressed air discharged by the compressor, extract thermal energy from the compressed air, and discharge a cooled compressed air;
an air storage unit configured to receive and store the cooled compressed air discharged by the first heat exchanger and discharge a stored compressed air;
a thermal storage device configured to receive and store the thermal energy extracted by the first heat exchanger;
a second heat exchanger configured to transfer thermal energy stored by the thermal storage device to the stored compressed air discharged by the air storage unit and discharge a heated compressed air;
a very high pressure expander configured to receive and expand the heated compressed air discharged by the second heat exchanger, produce power, and discharge an expanded air;
a recuperator configured to receive and heat the expanded air from the very high pressure expander and discharge a heated expanded air;
a high pressure combustor configured to receive the heated expanded air, combust a first fuel mixture comprising the heated expanded air, and discharge a first exhaust gas;
a high pressure expander configured to receive and expand the first exhaust gas discharged by the high pressure combustor, produce power, and discharge a first expanded exhaust gas;
a low pressure combustor configured to receive the first expanded exhaust gas, combust a second fuel mixture comprising the first expanded exhaust gas, and discharge a second exhaust gas; and
a low pressure expander configured to receive and expand the second exhaust gas discharged by the low pressure combustor, produce power, and discharge a second expanded exhaust gas, and wherein the recuperator is further configured to receive and cool the second expanded exhaust gas and discharge a cooled exhaust gas.

16. The hybrid compressed air energy storage system of claim 15, wherein at least one of the high pressure combustor and the low pressure combustor comprises a duct burner.

17. A method for storing and recovering energy by a hybrid compressed air energy storage system, comprising:
compressing air with a compressor to produce a compressed air during an storage period;
extracting thermal energy from the compressed air to produce a cooled compressed air;
storing the cooled compressed air in an air storage unit;
storing the extracted thermal energy in a thermal storage device;
heating the stored cooled compressed air with the stored extracted thermal energy to produce a heated compressed air during a generation period;
expanding the heated compressed air with a first expander to generate power and discharge an expanded air;
heating the expanded air with a recuperator to produce a heated expanded air, wherein the expanded air is heated by thermal energy extracted from an expanded exhaust gas;
combusting a fuel mixture comprising the heated expanded air to produce an exhaust gas;
expanding the exhaust gas with a second expander to generate power and discharge the expanded exhaust gas; and
transferring the expanded exhaust gas to the recuperator.

18. The method of claim 17, wherein the heated compressed air is discharged from the second heat exchanger at a temperature of about 400° F. (204° C.) to about 800° F. (427° C.).

19. The method of claim 17, wherein the cooled exhaust gas is discharged from the recuperator at a temperature of about 100° F. (38° C.) to less than 300° F. (149° C.).

20. The method of claim 17, wherein the heated compressed air expanded by the first expander is heated solely by the thermal energy transferred from the thermal storage device.
